(19) United States
(12) Patent Application Publication
(10) Pub. No.: US 2008/0194753 A1
(43) Pub. Date: Aug. 14, 2008

(54) Aqueous Dispersions of Water-Soluble and/or Water/Swellable Anionic Polymers, Method for the Production Thereof and Use Thereof

(75) Inventors: Pulakesh Mukherjee, Mannheim (DE); Roland Nowack, Birkenheide (DE); Henning Bolter, Wattenheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/914,242

(22) PCT Filed: May 17, 2006
(86) PCT No.: PCT/EP06/62380

§ 371 Date: Nov. 13, 2007

(30) Foreign Application Priority Data
May 19, 2005 (DE) 10 2005 023 799.1

(51) Int. Cl. C08F 2/08

(52) U.S. Cl. 524/461

(57) ABSTRACT

An aqueous dispersion of water-soluble and/or water-swellable anionic polymers which are obtainable by free radical polymerization of ethylenically unsaturated, anionic monomers in an aqueous medium in the presence of at least one stabilizer, the polymerization being carried out in the presence of at least one water-soluble polymer of the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, polyalkylene glycols endcapped at one or both ends with alkyl, carboxyl or amino groups
   and
(b) water-soluble copolymers from the group consisting of
   homo- and copolymers of anionic monomers,
   copolymers of anionic and cationic and, if appropriate, neutral monomers, the proportion of the anionic monomers incorporated in the form of polymerized units being greater than that of cationic monomers and
   copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate
      as a stabilizer, processes for the preparation of the aqueous dispersions by free radical polymerization of ethylenically unsaturated, anionic monomers in an aqueous medium in the presence of a stabilizer of the abovementioned groups (a) and (b) and use of the aqueous dispersions as thickeners for paper coating slips, pigment print pastes, print pastes for transfer printing, dispersion printing, printing with acid and metal complex dyes, reactive printing and vat printing, for tertiary mineral oil production, for consolidating nonwovens, for water-based paints, pharmaceutical products, dental compounds, agrochemicals and extinguishing agents and as coating materials and as an additive in detergents and cleaning agents.

The invention relates to aqueous dispersions of water-soluble and/or water-swellable anionic polymers which are obtainable by free radical polymerization of anionic monomers in an aqueous medium in the presence of at least one stabilizer, their preparation and their use as thickeners for aqueous systems.

U.S. Pat. No. 4,380,600 discloses a process for the preparation of aqueous dispersions of water-soluble polymers, water-soluble monomers which form water-soluble polymers being polymerized in an aqueous solution of at least one other polymer, such as polyethylene glycol, polyvinylpyrrolidone or starch, in the presence of free radical initiators. The aqueous solution of the other polymer, which is initially taken in the polymerization, comprises from 3 to 150 parts by weight of the water-soluble polymer, based on 100 parts by weight of water. The amount of water-soluble monomers used in the polymerization, such as acrylic acid, sodium acrylate or acrylamide, is from 10 to 150 parts by weight, based on 100 parts by weight of water. In order to increase the stability of the resulting aqueous dispersions of water-soluble polymers, the polymerization can additionally be carried out in the presence of surface-active agents and, if required, also in the presence of water-soluble inorganic salts, such as sodium chloride or potassium sulfate.

EP-A 183 466 discloses a process for the preparation of aqueous dispersions of water-soluble polymers, the water-soluble monomers being polymerized in an aqueous solution which comprises a salt, e.g. ammonium sulfate, and a polymeric dispersant, e.g. polyols, polyethylene glycol and/or polypropylene glycol having a molecular weight of up to 600, cationic or anionic polyelectrolytes. With the exception of homopolymers of special cationic monomers, no homopolymers of ionic monomers can be prepared by this process, cf. EP-A 183 466, page 5, lines 2 to 6. As the examples show, however, copolymers of acrylamide and acrylic acid can be prepared.

U.S. Pat. No. 5,605,970 discloses a process for the preparation of aqueous dispersions of high molecular weight anionic polymers. In this process, an aqueous solution of acrylic acid is polymerized with addition of from 2 to 20% by weight of ammonium sulfate, glycerol, ethylene glycol and a low molecular weight terpolymer of 66 mol % of acrylic acid, 22 mol % of sodium acrylate and 12 mol % of ethylhexyl acrylate in the presence of from 3 to 14 mol % of ethylhexyl acrylate and a polymerization initiator at a pH below 4.5 with formation of an aqueous dispersion of high molecular weight terpolymer of acrylic acid, sodium acrylate and ethylhexyl acrylate. The terpolymer is isolated after cooling. In the known process, it is essential to use an inorganic salt and a hydrophobic monomer, such as ethylhexyl acrylate. As a result of this, however, the properties of the anionic polymers are changed in an undesired manner.

Moreover, aqueous dispersions of water-soluble polymers of N-vinylcarboxamides are known. They are prepared according to the teaching of WO 03/046024 by polymerization of N-vinylcarboxamides in an aqueous medium in the presence of polymeric stabilizers, such as polyethylene glycol, polypropylene glycol, polyvinyl acetate, polyvinyl alcohol, polyvinylimidazole or polydiallyldimethylammonium chloride, or are obtained by polymerization of N-vinylcarboxamides in aqueous solutions which have high concentrations of inorganic salts, cf. the examples in EP-B 0 984 990.

WO 97/34933 discloses aqueous dispersions of high molecular weight nonionic or anionic polymers, which are prepared by polymerization of the monomers in a saturated aqueous salt solution with addition of an anionic, water-soluble polymer stabilizer. Preferably used monomers are acrylamide and/or acrylic acid. Suitable polymer stabilizers are, for example, anionically charged water-soluble polymers having a molar mass of from 100 000 to 5 million, such as polymers of acrylamidomethylpropanesulfonic acid. They are used in amounts of, for example, from 0.1 to 5% by weight, based on the total dispersion. During the polymerization, the pH in the range from 2 to 5 must be maintained.

Aqueous dispersions of water-soluble anionic polymers which comprise inorganic salts in dissolved form cannot be used, for example, as thickeners for aqueous systems, such as paper coating slips, because the inorganic salts greatly reduce the viscosity of the system to be thickened. This property is known as the “salt poisoning effect”.

DE-A 103 38 828 discloses aqueous dispersions of water-soluble, anionic polymers, which are obtainable by free radical polymerization of ethylenically unsaturated anionic monomers in an aqueous medium in the presence of at least one stabilizer, at least one water-soluble polymer from the groups consisting of
(a) graft polymers of vinyl acetate and/or vinyl propionate on polyethylene glycols, polyethylene glycols endcapped at one or both ends with alkyl, carboxyl or amino groups, copolymers of alkylpolyalkylene glycol acrylates or alkylpolyalkylene glycol methacrylates and acrylic acid and/or methacrylic acid, polyalkylene glycols having molar masses M_{N} of from 1000 to 100 000, polyalkylene glycols endcapped at one or both ends with alkyl, carboxyl or amino groups and having molar masses M_{N} of from 1000 to 100 000
   and
(b) hydrolyzed copolymers of vinyl alkyl ethers and maleic anhydride in the form of the free carboxyl groups and in the form of the salts at least partly neutralized with alkali metal hydroxides or ammonium bases and/or a water-soluble starch from the group consisting of cationically modified potato starch, anionically modified potato starch, degraded potato starch and maltodextrin
   being used as a stabilizer. The aqueous dispersions are used as thickeners for aqueous systems, such as paper coating slips, pigment print pastes and leather treatment compositions.

The prior Application DE-A 10 2004 038 983.7 likewise discloses aqueous dispersions of water-soluble and/or water-swellable polymers, which are obtainable by free radical polymerization of ethylenically unsaturated, anionic monomers in an aqueous medium in the presence of at least one stabilizer, the polymerization being carried out in the presence of at least one water-soluble polymer of the groups consisting of
(a) graft polymers of vinyl acetate and/or vinyl propionate on (i) polyethylene glycols and (ii) polyethylene glycols or polypropylene glycols endcapped at one or both ends with alkyl, carboxyl or amino groups, polyalkylene glycols, polyalkylene glycols endcapped at one or both ends with alkyl, carboxyl or amino groups
   and
(b) water-soluble copolymers of
(b1) nonionic monoethylenically unsaturated monomers,
(b2) cationic monoethylenically unsaturated monomers and, if appropriate,
(b3) anionic monoethylenically unsaturated monomers, the proportion of the cationic monomers incorporated in the form of polymerized units being greater than that of the anionic monomers
   as a stabilizer.

It is the object of the invention to provide further aqueous dispersions of water-soluble anionic polymers, in the preparation of which no stabilizing inorganic salts have to be used, so that the resulting dispersions are virtually free of such salts.

The object is achieved, according to the invention, by aqueous dispersions of water-soluble and/or water-swellable anionic polymers which are obtainable by free radical polymerization of ethylenically unsaturated, anionic monomers in an aqueous medium in the presence of at least one stabilizer, if the polymerization is carried out in the presence of at least one water-soluble polymer of the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, polyalkylene glycols endcapped at one or both ends with alkyl, carboxyl or amino groups
   and
(b) water-soluble copolymers from the group consisting of
   homo- and copolymers of anionic monomers,
   copolymers of anionic and cationic and, if appropriate, neutral monomers, the proportion of the anionic monomers incorporated in the form of polymerized units being greater than that of cationic monomers and
   copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate
      as a stabilizer.

Suitable ethylenically unsaturated, anionic monomers for the preparation of the aqueous dispersions are, for example, monoethylenically unsaturated C₃- to C₅-carboxylic acids, such as acrylic acid, methacrylic acid, ethacrylic acid, crotonic acid, maleic acid, fumaric acid, vinylsulfonic acid, styrenesulfonic acid, acrylamidomethylpropanesulfonic acid, vinylphosphonic acid, itaconic acid and/or the alkali metal or ammonium salts of these acids. The preferably used anionic monomers include acrylic acid, methacrylic acid, maleic acid and acryalmido-2-methylpropanesulfonic acid. Aqueous dispersions of polymers based on acrylic acid are particularly preferred. The anionic monomers can be polymerized either alone to give homopolymers or as a mixture with one another to give copolymers. Examples of these are the homopolymers of acrylic acid or copolymers of acrylic acid with methacrylic acid and/or maleic acid.

The polymerization of the anionic monomers can, however, also be carried out in the presence of other ethylenically unsaturated monomers. These monomers may be nonionic or may carry a cationic charge. Examples of such comonomers are acrylamide, methacrylamide, acrylates of monohydric alcohols having 1 to 20 carbon atoms, methacrylates of monohydric alcohols having 1 to 20 carbon atoms, vinyl acetate, vinyl propionate, dialkylaminoethyl (meth)acrylates, dialkylaminopropyl (meth)acrylates, diallyldimethylammonium chloride, N-vinylformamide, vinylimidazole and quaternized vinylimidazole and partly or completely neutralized or quaternized dialkylaminoalkyl(meth)acrylamides. Basic monomers, such as dialkylaminoalkyl (meth)acrylates, e.g. dimethylaminoethyl acrylate or dimethylaminoethyl methacrylate, can be used in the polymerization both in the form of the free bases and in partly or completely neutralized form or in a form quaternized, for example, with C₁- to C₁₈-alkyl halides. The comonomers are used in the preparation of the anionic polymers, for example, in amounts such that the resulting polymers are water-soluble and have an anionic charge. Based on the monomers used altogether in the polymerization, the amount of nonionic and/or cationic comonomers is, for example, from 0 to 99, preferably from 5 to 75, % by weight.

Preferred copolymers are, for example, copolymers of from 25 to 90% by weight of acrylic acid and from 75 to 10% by weight of acrylamide. Particularly preferred are homopolymers of acrylic acid, which are obtainable by free radical polymerization of acrylic acid in the absence of other monomers, and copolymers of acrylic acid and/or methacrylic acid which can be prepared by copolymerization of acrylic acid and/or methacrylic acid in the presence of pentaerythrityl triallyl ether, N,N′-divinylethyleneurea, methylenebisacrylamide, esters of dihydric alcohols having 2 to 8 carbon atoms and C₃- to C₅-carboxylic acids, ethoxylated trimethylolpropane triacrylate, ethoxylated trimethylolpropane trimethacrylate, pentaerythrityl triacrylate, pentaerythrityl tetraacrylate, triallylmethylammonium chloride, allyl ethers of sugars, which allyl ethers comprise at least two allyl groups, vinyl ethers having at least two vinyl groups or triallylamine and mixtures of these compounds.

The polymerization can additionally be carried out in the presence of at least one crosslinking agent. Copolymers having a higher molar mass than in the case of the polymerization of the anionic monomers in the absence of a crosslinking agent are then obtained. The incorporation of a crosslinking agent into the polymers also leads to a lower solubility of the polymers in water. Depending on the amount of crosslinking agent incorporated in the form of polymerized units, the polymers become water-insoluble but are swellable in water. There are fluid transitions between complete solubility of the polymers in water and the swelling of the polymers in water. Owing to their swellability in water, crosslinked copolymers have a high water absorptivity. They can be used, for example, as thickeners for aqueous systems, such as paper coating slips.

Crosslinking agents which may be used are all compounds which have at least two ethylenically unsaturated double bonds in the molecule. Such compounds are used, for example, in the preparation of crosslinked polyacrylic acids, such as superabsorbent polymers, cf. EP-A 858 478, page 4, line 30 to page 5, line 43. Examples of crosslinking agents are triallylamine, pentaerythrityl triallyl ether, methylenebisacrylamide, N,N′-divinylethyleneurea, allyl ethers, comprising at least two allyl groups, or vinyl ethers, having at least two vinyl groups, of polyhydric alcohols, such as, for example, sorbitol, 1,2-ethanediol, 1,4-butanediol, trimethylolpropane, glycerol, diethylene glycol, and of sugars, such as sucrose, glucose or mannose, dihydric alcohols completely esterified with acrylic acid or methacrylic acid and having 2 to 4 carbon atoms, such as ethylene glycol dimethacrylate, ethylene glycol diacrylate, butanediol dimethacrylate, butanediol diacrylate, diacrylates or dimethacrylates of polyethylene glycols having molecular weights of from 300 to 600, ethoxylated trimethylolpropane triacrylates or ethoxylated trimethylolpropane trimethacrylates, 2,2-bis(hydroxymethyl)butanol trimethacrylate, pentaerythrityl triacrylate, pentaerythrityl tetraacrylate and triallylmethylammonium chloride. If crosslinking agents are used in the preparation of the anionic dispersions, the amounts of crosslinking agent used in each case are, for example, from 0.0005 to 5.0, preferably from 0.001 to 1.0, % by weight, based on the monomers used altogether in the polymerization. Preferably used crosslinking agents are pentaerythrityl triallyl ether, N,N′-divinylethyleneurea, allyl ethers, comprising at least two allyl groups, of sugars such as sucrose, glucose or mannose, and triallylamine and/or ethoxylated trimethylolpropane triacrylate and mixtures of these compounds.

The polymerization can additionally be carried out in the presence of at least one chain transfer agent. Polymers which have a lower molar mass than polymers prepared without chain transfer agents are then obtained. Examples of chain transfer agents are compounds which comprise sulfur in bound form, such as dodecyl mercaptan, thiodiglycol, ethylthioethanol, di-n-butyl sulfide, di-n-octyl sulfide, diphenyl sulfide, diisopropyl sulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid and thiourea, aldehydes, organic acids, such as formic acid, sodium formate or ammonium formate, alcohols, such as, in particular, isopropanol, and phosphorus compounds, e.g. sodium hypophosphite. It is possible to use a single chain transfer agent or a plurality of chain transfer agents in the polymerization. If they are used in the polymerization, they are employed, for example, in an amount of from 0.01 to 5.0, preferably from 0.2 to 1, % by weight, based on the total monomers. The chain transfer agents are preferably used together with at least one crosslinking agent in the polymerization. By varying the amount and the ratio of chain transfer agent and crosslinking agent, it is possible to control the rheology of the resulting polymers. Chain transfer agent and/or crosslinking agent can be initially taken in the polymerization, for example in the aqueous polymerization medium, or can be metered into the polymerization batch together with or separately from the monomers, according to the progress of the polymerization.

In the polymerization, initiators which form free radicals under the reaction conditions are usually used. Suitable polymerization initiators are, for example, peroxides, hydroperoxides, hydrogen peroxide, sodium or potassium persulfate, redox catalysts and azo compounds, such as 2,2-azobis(N,N-dimethyleneisobutyramidine) dihydrochloride, 2,2-azobis(4-methoxy-2,4-dimethylvaleronitrile), 2,2-azobis(2,4-dimethylvaleronitrile) and 2,2-azobis(2-amidinopropane) dihydrochloride. The initiators are used in the amounts customary in the polymerization. Azo initiators are preferably used as polymerization initiators. However, the polymerization can also be initiated with the aid of high-energy radiation, such as electron beams, or by exposure to UV light.

The aqueous dispersions of the water-soluble anionic polymers have a polymer concentration of anionic polymers of, for example, from 1 to 70% by weight, in general from 5 to 50, preferably from 10 to 25 and particularly preferably from 15 to 20% by weight. According to the invention, they comprise at least two different groups of the abovementioned polymers (a) and (b) for stabilizing the anionic polymers forming in the polymerization. The amount of stabilizers (a) and (b) in the aqueous dispersion is, for example, from 1 to 40% by weight, in general from 5 to 30% by weight and preferably from 10 to 25% by weight. The aqueous dispersions have, for example at a pH of 2.5, viscosities in the range from 200 to 100 000 mPa·s, preferably from 200 to 20 000 mPa·s, preferably from 200 to 10 000 mPa·s (measured in a Brookfield viscometer at 20° C., spindle 6, 100 rpm).

The stabilizers of group (a) include graft polymers of vinyl acetate and/or vinyl propionate on (i) polyethylene glycols or (ii) polyethylene glycols or polypropylene glycols endcapped at one or both ends with alkyl, carboxyl or amino groups, and moreover polyalkylene glycols and polyalkylene glycols endcapped at one or both ends with alkyl, carboxyl or amino groups.

Polyalkylene glycols are described, for example, in WO 03/046024, page 4, line 37 to page 8, line 9. The polyalkylene glycols described therein can be used either directly as a stabilizer of group (a) or can be modified so that, for example, from 10 to 1000, preferably from 30 to 300, parts by weight of vinyl acetate and/or vinyl propionate are grafted onto 100 parts by weight of the polyalkylene glycols. Preferably, polyethylene glycol having a molecular weight M_{N} of from 1000 to 100 000 is used as the grafting base and vinyl acetate is grafted thereon.

Further suitable stabilizers (a) are the abovementioned polyalkylene glycols and the polyalkylene glycols endcapped at one or both ends with alkyl, carboxyl or amino groups. The abovementioned polymers have, for example, molar masses M_{N} of from 100 to 100 000, preferably from 300 to 80 000, particularly preferably from 600 to 50 000 and in particular from 1000 to 50 000. Such polymers are described, for example, in the above-cited WO 03/046024, page 4, line 37 to page 8, line 9. Preferred polyalkylene glycols are for example polyethylene glycol, polypropylene glycol and block copolymers of ethylene oxide and propylene oxide. The block copolymers may comprise, incorporated in the form of polymerized units, ethylene oxide and propylene oxide in any desired amounts and in any desired sequence. The terminal OH groups of the polyalkylene glycols can, if appropriate, be endcapped at one or both ends with alkyl, carboxyl or amino groups, a methyl group being preferred as a terminal group.

Particularly preferably used stabilizers of group (a) are copolymers of ethylene oxide and propylene oxide. Block copolymers of ethylene oxide and propylene oxide having a molar mass M_{N} of from 500 to 20 000 g/mol and a content of ethylene oxide units of from 10 to 80 mol % are particularly preferred.

The water-soluble polymers of group (a) are used, for example, in amounts of from 1 to 39.5% by weight, preferably from 5 to 30% by weight and particularly preferably from 10 to 25% by weight, based on the total dispersion, in the preparation of the dispersions.

Polymers of the group (b) which are used are water-soluble copolymers from the group consisting of the
homo- and copolymers of anionic monomers,
copolymers of anionic and cationic and, if appropriate, neutral monomers, the proportion of the anionic monomers incorporated in the form of polymerized units being greater than that of cationic monomers, and
copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate.

Water-soluble polymers of group (b) which are used are, for example, at least one homopolymer of an ethylenically unsaturated C₃- to C₅-carboxylic acid, vinylsulfonic acid, styrenesulfonic acid, acrylamidomethylpropanesulfonic acid, vinylphosphonic acid, the salts thereof which are partly or completely neutralized with alkali metal and/or ammonium bases and/or at least one copolymer of these monomers. Examples of ethylenically unsaturated carboxylic acids have already been mentioned above in the case of the anionic monomers which are used for the preparation of the aqueous dispersions. These anionic monomers can likewise be used for the preparation of the polymers of component (b) of the stabilizer mixtures. Acrylic acid, methacrylic acid, acrylamidomethylpropanesulfonic acid and/or mixtures in any desired ratio are preferred for this purpose.

Further suitable water-soluble polymers of group (b) of the stabilizer mixture are water-soluble copolymers of
(i) at least one ethylenically unsaturated C₃- to C₅-carboxylic acid, vinylsulfonic acid, styrenesulfonic acid, acrylamidomethylpropanesulfonic acid, vinylphosphonic acid and/or the alkali metal and/or ammonium salts thereof,
(ii) at least one cationic monomer from the group consisting of partly or completely neutralized dialkylaminoalkyl (meth)acrylates, partly or completely quaternized dialkylaminoalkyl (meth)acrylates, dialkylaminoalkyl(meth)acrylamides in quaternized or neutralized form, dialkyldiallylammonium halides and quaternized N-vinylimidazole and, if appropriate,
(iii) at least one neutral monomer,
   the proportion of the anionic monomers incorporated in the form of polymerized units being greater than that of the cationic monomers.

Examples of anionic monomers (i) have already been mentioned above. Suitable cationic monomers (ii) are, for example, dialkylaminoalkyl (meth)acrylates, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, diethylaminopropyl acrylate and diethylaminopropyl methacrylate, dialkyldiallylammonium halides, such as dimethyldiallylammonium chloride and diethyldiallylammonium halides, such as dimethyldiallylammonium chloride and diethyldiallylammonium chloride, N-vinylimidazole, quaternized N-vinylimidazole and dialkylaminoalkylacrylamides, such as dimethylaminoethylacrylamide or dimethylaminoethylmethacrylamide. Basic monomers, such as dimethylaminoethyl acrylate or dimethylaminoethyl methacrylate, can be used both in the form of the free bases and in the form partly or completely neutralized with acids, such as hydrochloric acid, sulfuric acid, formic acid and p-toluenesulfonic acid. The basic monomers can also be partly or completely quaternized with C₁- to C₁₈-alkyl halides and/or C₁- to C₁₈-alkylaryl halides and can be used in this form in the polymerization. Examples of these are the dimethylaminoethyl (meth)acrylates completely quaternized with methyl chloride, such as dimethylaminoethyl acrylate methochloride or dimethylaminoethyl (meth)acrylate methochloride. The polymers of group (b) may also comprise vinylamine units as cationic groups. Such polymers are obtainable, for example, by polymerizing N-vinylformamide, if appropriate together with at least one anionic water-soluble monomer, and then hydrolyzing the polymers with partial elimination of formyl groups to give polymers comprising vinylamine units.

For example, the esters of anionic monomers, in particular of C₃- to C₅-carboxylic acids, and monohydric alcohols having 1 to 20 carbon atoms, such as, in particular, methyl acrylate, methyl methacrylate, ethyl acrylate, n-butyl acrylate, sec-butyl acrylate and tert-butyl acrylate, 2-ethylhexyl acrylate, ethyl methacrylate, isopropyl acrylate, isopropyl methacrylate and n-butyl, sec-butyl and tert-butyl methacrylate, and acrylamide, methacrylamide, acrylonitrile, methacrylonitrile, N-vinylpyrrolidone, N-vinylimidazole, N-vinylformamide, vinyl acetate, vinyl propionate and styrene may be used as neutral monomers (iiii).

In the case of the amphoteric copolymers suitable as component (b), the proportion of the anionic monomers incorporated in the form of polymerized units is always greater than that of the cationic monomers. These copolymers thus always carry an anionic charge.

Other suitable copolymers of group (b) are water-soluble copolymers of
(i) at least one anionic monomer and
(ii) at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate,
   for example copolymers of acrylic acid, methyl acrylate and N-vinylpyrrolidone or copolymers of methacrylic acid, acrylamidomethylpropanesulfonic acid, methyl acrylate and vinylimidazole.

The water-soluble polymers (b) may comprise the suitable monomers in any desired ratios incorporated in the form of polymerized units, only the amphoteric copolymers having a composition such that they always carry an anionic charge. The average molar mass M_{w} of the polymers of group (b) of the stabilizer mixture is, for example, up to 1.5 million, in general up to 1.2 million and preferably in the range from 1000 to 1 million, in general from 1500 to 100 000 and in particular from 2000 to 70 000 (determined by the light scattering method).

The polymers (b) can also be characterized with the aid of the K value. They have, for example, a K value of from 15 to 200, preferably from 30 to 150 and particularly preferably from 45 to 110 (determined according to H. Fikentscher, Cellulose-Chemie, Volume 13, 58-64 and 71-74 (1932) in 3% strength by weight aqueous sodium chloride solution at 25° C., a polymer concentration of 0.1% by weight and a pH of 7).

The aqueous dispersions according to the invention comprise the polymers of group (b), for example, in amounts of from 0.5 to 15, preferably from 1 to 10, % by weight.

The aqueous dispersions of the anionic polymers preferably comprise, as a stabilizer, a combination of
(a) at least one block copolymer of ethylene oxide and propylene oxide
   and
(b) at least one copolymer of methacrylic acid and acrylamidomethylpropanesulfonic acid, copolymer of methyl acrylate, acrylamidomethylpropanesulfonic acid and quaternized vinylimidazoles having an overall anionic charge, water-soluble copolymer of acrylamidomethylpropanesulfonic acid, acrylic acid, methyl acrylate and styrene, polyacrylic acid, polymethacrylic acid and polyacrylamidomethylpropanesulfonic acid.

The ratio of components (a) and (b) in the stabilizer mixtures can be varied within a wide range. It may be, for example, from 50:1 to 1:10. Preferably, a ratio of (a):(b) of at least 1.5:1, in particular from 7:1 to 10:1, is chosen.

The invention also relates to a process for the preparation of aqueous dispersions of water-soluble and/or water-swellable anionic polymers by free radical polymerization of ethylenically unsaturated, anionic monomers in an aqueous medium in the presence of at least one stabilizer, the polymerization being carried out in the presence of at least one water-soluble polymer of the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, polyalkylene glycols endcapped at one or both ends with alkyl, carboxyl or amino groups
   and
(b) water-soluble copolymers from the group consisting of
   homo- and copolymers of anionic monomers,
   copolymers of anionic and cationic and, if appropriate, neutral monomers, the proportion of the anionic monomers incorporated in the form of polymerized units being greater than that of cationic monomers and
   copolymers of at least one anionic monomer and at least one monomer from the group consisting of the esters of anionic monomers with monohydric alcohols, styrene, N-vinylpyrrolidone, N-vinylimidazole, N-vinylformamide, acrylamide, methacrylamide, vinyl acetate and vinyl propionate
      as a stabilizer.

Stable aqueous dispersions of anionic polymers having a particle size of from 0.1 to 200 μm, preferably from 0.5 to 70 μm, are obtained. The particle size can be determined, for example, by optical microscopy, light scattering or freeze fraction electron microscopy. The aqueous dispersions are prepared, for example, at a pH of from 0.5 to 9, preferably from 1 to 5. At a pH below 9, dispersions having a content of anionic polymers of from about 5 to 35% by weight have a relatively low viscosity. If, however, they are diluted to a content of anionic polymers of less than 4% by weight, the viscosity of the mixture increases considerably.

The invention also relates to the use of the aqueous dispersions as thickeners for aqueous systems, for example as thickeners for paper coating slips, pigment print pastes, print pastes for transfer printing, dispersion printing, printing with acid and metal complex dyes, reactive printing and vat printing, for tertiary mineral oil production, for consolidating nonwovens, for water-based paints, for dental compounds, for pharmaceutical products, agrochemicals and extinguishing agents. The aqueous dispersions according to the invention can moreover be used as coating materials for substrates, such as paper, wood, glass, metal and ceramic articles, and as an additive to detergents and cleaning agents. They are also suitable as a matrix for the controlled release of active substances in pharmaceutical formulations and of agrochemicals.

The aqueous dispersions of the anionic polymers are preferably used as thickeners, for example as an additive to paper coating slips, as thickeners for pigment print pastes, print pastes for transfer printing, dispersion printing, printing with acid and metal complex dyes, reactive printing and vat printing and as an additive to water-based paints, such as masonry paints, and for consolidating nonwovens, and for the surface treatment of leather. The aqueous dispersions of the anionic polymers can be used in general as rheology modifiers of preparations, such as, for example, pigment print pastes.

A special application form of the aqueous dispersions, according to the invention, of the anionic polymers is in the production of printed flexible substrates, in particular printed textiles. Methods for printing textile materials are described in detail, for example, in WO 02/012378, page 12, line 4, to page 16, line 34. The statements made there apply in a corresponding manner to the use of the aqueous polymer dispersions according to the invention for the printing of textile materials.

The aqueous dispersions, according to the invention, of water-soluble and/or water-swellable polymers are also used together with at least one neutralizing agent as an additive to aqueous extinguishing agents. An aqueous extinguishing agent is to be understood primarily as meaning water, which, if appropriate, may additionally comprise at least one flameproofing agent, one dye and/or one wetting agent. An example of a suitable flameproofing agent is ammonium polyphosphate. Suitable wetting agents are all surface-active substances, such as ethoxylated alcohols having at least 12 carbon atoms in the molecule, ethoxylated phenols and/or ethoxylated polyols, such as glycerol or polyethylene glycols.

The preparation of the extinguishing agents can be effected batchwise by a batch process or continuously. For example, an aqueous dispersion of a water-soluble and/or water-swellable anionic polymer is diluted with water to a polymer concentration of not more than 5% by weight, and the resulting aqueous solution is adjusted to a pH of at least 5.5 by adding at least one water-soluble neutralizing agent. Preferably, the aqueous polymer dispersion is diluted by introducing it simultaneously but separately from the feed point of the polymer dispersion with the neutralizing agent in water and stirring the resulting mixture. The neutralizing agent can, however, also be initially taken in the water used for the dilution or can be metered after addition of the polymer dispersion. However, the polymer dispersion can, for example, be diluted with water continuously in a mixing chamber or in a multi-material nozzle under the action of a shearing field and at the same time at least one water-soluble neutralizing agent can be added. The pH of the aqueous extinguishing agent is preferably in the range from 6 to 13, in particular from 7 to 12.

The polymer concentration of the aqueous extinguishing agent is in general from 0.01 to 2.5% by weight. It is preferably in the range from 0.1 to 2.0% by weight. These extinguishing agents have, for example, a viscosity of from at least 1000 mPa·s to 100 000 mPa·s, and in general the viscosity of the extinguishing agents is above 5000 mPa·s, preferably above 8000 mPa·s and in particular above 15 000 mPa·s.

These viscosity data relate to the measurement using a Brookfield R/S rheometer, spindle V40203T01 at 20 rpm and a temperature of 23° C.

The extinguishing agents can be used, for example, in the fighting of fires with aqueous extinguishing agents in a manner such that an aqueous dispersion of at least one water-soluble and/or water-swellable anionic polymer and at least one water-soluble neutralizing agent is mixed in each case continuously with water so that the mixture has a polymer content of not more than 5% by weight, preferably not more than 2.0% by weight, and a pH of at least 5.5, preferably from 7.5 to 11. Such mixtures are then used directly for fire fighting.

Suitable neutralizing agents are, for example, an alkali metal, alkaline earth metal and/or ammonium base. Particularly preferred neutralizing agents are sodium hydroxide solution, potassium hydroxide solution, ammonia, ethanolamine, diethanolamine or triethanolamine. In addition, all other amines or polyamines, such as diethylenetriamine, triethylenetetramine, polyethyleneimines and/or polyvinylamines can be used as neutralizing agents.

The amount of neutralizing agent which is used depends substantially on the desired viscosity which the extinguishing medium is to have. This viscosity is dependent on the pH of the extinguishing agent, which is preferably in the range from 7.5 to 11. A preferred form for use is obtained by mixing an aqueous dispersion of water-soluble and/or water-swellable anionic polymers and at least one water-soluble neutralizing agent in each case continuously with water so that the mixture, i.e. the extinguishing agent, has a polymer content of not more than 5% by weight, for example from 0.1 to 2.5% by weight, in general from 1.0 to 2.0% by weight, and a pH of at least 5.5 and a viscosity of not more than 100 000 mPa·s (Brookfield viscometer, spindle V40203T01, 20 rpm, 23° C.).

The extinguishing agents thus obtainable are clear, pumpable gels which have a long shelf-life even at relatively high temperatures. During fire fighting, they adhere to perpendicular surfaces and effectively prevent excessively rapid evaporation of the extinguishing water. They are particularly suitable in extinguishing water which is applied from a relatively great height onto a fire, for example from a helicopter.

The K values of the polymers are determined according to H. Fikentscher, Cellulose-Chemie, Volume 13, 58-64 and 71-74 (1932) in 3% strength by weight aqueous sodium chloride solution at 25° C. and a concentration of 0.1% by weight.

The viscosities of the dispersions and solutions which are stated below were measured in each case in a Brookfield viscometer using a spindle No. 4 at 20 rpm and a temperature of 20° C. Unless stated otherwise, the data in % are percent by weight and the parts are parts by weight.

### EXAMPLES

The azo initiators stated in the examples have the following composition:

azo initiator VA-044: 2,2′-azobis(N,N′-dimethyleneisobutyramidine) dihydrochloride

azo initiator V-70: 2,2′-azobis(4-methoxy-2,4-dimethylvaleronitrile)

### Example 1

In a glass reactor which was equipped with an anchor stirrer and an apparatus for working under nitrogen, 489 g of demineralized water, 175 g of a block copolymer of ethylene oxide (EO) and propylene oxide (PO) having an EO content of 20% and a molar mass of 1750 g/mol of polypropylene glycol blocks and 120 g of a 20% strength aqueous solution of a copolymer of 59 parts of acrylamidomethylpropanesulfonic acid, 20 parts of methyl acrylate, 20 parts of acrylic acid and 1 part of styrene were initially taken while passing through nitrogen and stirring continuously at a speed of 200 rpm.

Thereafter, while stirring (200 rpm), a mixture of 174 g of acrylic acid and 1.5 g of pentaerythrityl triallyl ether (70% strength) was added dropwise in the course of 5 minutes and the resulting emulsion was heated to 40° C. After addition of a solution of 0.2 g of azo initiator VA-044 in 10 g of water and rinsing of the metering apparatus with 10 g of water, the reaction mixture was heated to a temperature of 40° C. and kept at this temperature for 4 hours. Thereafter, a solution of 0.3 g of azo initiator VA-044 in 10 g of demineralized water was metered, rinsing with 10 g of demineralized water was effected and the reaction mixture was then stirred for a further hour for postpolymerization at 40° C. A milky white dispersion having a viscosity of 18 800 mPa·s was obtained. A 0.5% strength aqueous solution had a viscosity of 26 600 mPa·s at pH 7.

### Example 2

In a glass reactor which was equipped with an anchor stirrer and an apparatus for working under nitrogen, 489 g of demineralized water, 175 g of a copolymer of 20.3 parts of propylene oxide and 14.2 parts of ethylene oxide and 120 g of a 20% strength aqueous solution of a copolymer of 59 parts of acrylamidomethylpropanesulfonic acid, 20 parts of methyl acrylate, 20 parts of acrylic acid and 1 part of styrene were initially taken while passing through nitrogen and stirring continuously at a speed of 200 rpm.

Thereafter, while stirring (200 rpm), a mixture of 174 g of acrylic acid and 1.5 g of pentaerythrityl triallyl ether (70% strength) was added dropwise in the course of 5 minutes and the resulting emulsion was heated to 40° C. After addition of a solution of 0.2 g of azo initiator VA-044 in 10 g of water and rinsing with 10 g of water, the reaction mixture was heated to a temperature of 40° C. and polymerized at this temperature for 4 hours. Thereafter, a solution of 0.3 g of azo initiator VA-044 in 10 g of demineralized water was metered, rinsing with 10 g of demineralized water was effected and the reaction mixture was then stirred for a further hour for postpolymerization at 40° C. A milky white dispersion having a viscosity of 19 600 mPa·s was obtained. A 0.5% strength aqueous solution had a viscosity of 22 400 mPa·s at pH 7.

### Example 3

Example 1 was repeated, with the exceptions that 359 g of demineralized water, 87.5 g of a block copolymer of ethylene oxide (EO) and propylene oxide (PO) having an EO content of 20% and a molar mass of 1750 g/mol of the polypropylene glycol block, 87.5 g of a copolymer of 20.3 parts of propylene oxide and 14.2 parts of ethylene oxide, and 250 g of a 10% strength aqueous solution of a copolymer of 90 mol % of methacrylic and 10 mol % of the sodium salt of acrylamidomethylpropanesulfonic acid were initially taken in the polymerization reactor. A white dispersion having a viscosity of 1000 mPa·s was obtained. A 0.5% strength aqueous solution prepared therefrom had a viscosity of 30 000 mPa·s at a pH of 7.

### Example 4

Example 3 was repeated with the only exception that, instead of the copolymer of 90 mol % of methacrylic acid and 10 mol % of the sodium salt of acrylamidomethylpropanesulfonic acid, a copolymer composed of 10 mol % of methacrylic acid and 90 mol % of the sodium salt of acrylamidomethylpropanesulfonic acid was now used. An aqueous dispersion having a viscosity of 1500 mPa·s was obtained. An aqueous solution of the dispersion, diluted to 0.5%, had a viscosity of 25 000 mPa·s at a pH of 7.

### Example 5

Example 3 was repeated with the only exception that, instead of the copolymer of 90 mol % of methacrylic acid and 10 mol % of the sodium salt of acrylamidomethylpropanesulfonic acid, a copolymer composed of 50 mol % of methacrylic acid and 50 mol % of the sodium salt of acrylamidomethylpropanesulfonic acid was now used. An aqueous dispersion having a viscosity of 1200 mPa·s was obtained. An aqueous solution of the dispersion, diluted to 0.5%, had a viscosity of 35 000 mPa·s at a pH of 7.

### Example 6

Example 3 was repeated with the only exception that, instead of the copolymer of 90 mol % of methacrylic acid and 10 mol % of the sodium salt of acrylamidomethylpropanesulfonic acid, a copolymer composed of 80 mol % of methacrylic acid and 20 mol % of the sodium salt of acrylamidomethylpropanesulfonic acid was now used. An aqueous dispersion having a viscosity of 1300 mPa·s was obtained. An aqueous solution of the dispersion, diluted to 0.5%, had a viscosity of 33 000 mPa·s at a pH of 7.

### Example 7

Example 3 was repeated with the only exception that, instead of the copolymer of 90 mol % of methacrylic acid and 10 mol % of the sodium salt of acrylamidomethylpropanesulfonic acid, a copolymer composed of 70 mol % of methacrylic acid and 30 mol % of the sodium salt of acrylamidomethylpropanesulfonic acid was now used. An aqueous dispersion having a viscosity of 1100 mPa·s was obtained. An aqueous solution of the dispersion, diluted to 0.5%, had a viscosity of 29 000 mPa·s at a pH of 7.

### Example 8

In a glass reactor which was equipped with an anchor stirrer and an apparatus for working under nitrogen, 359 g of demineralized water, 87.5 g of a block copolymer of ethylene oxide (EO) and propylene oxide (PO) having an EO content of 20% and a molar mass of 1750 g/mol of the polypropylene glycol block, 87.5 g of a copolymer of 20.3 parts of propylene oxide and 14.2 parts of ethylene oxide and 250 g of a 10% strength aqueous solution of a copolymer of 80 mol % of methacrylic acid and 20 mol % of the sodium salt of acrylamidomethylpropanesulfonic acid were initially taken while passing through nitrogen and stirring continuously at a speed of 200 rpm.

Thereafter, while stirring (200 rpm), a mixture of 174 g of acrylic acid and 1.75 g of pentaerythrityl triallyl ether (70% strength) was added dropwise in the course of 5 minutes and the resulting emulsion was heated to 50° C. After addition of a solution of 0.2 g of azo initiator VA-044 in 10 g of water and rinsing of the metering apparatus with 10 g of water, the reaction mixture was heated to a temperature of 50° C. and polymerized at this temperature for 4 hours. Thereafter, a solution of 0.3 g of azo initiator VA-044 in 10 g of demineralized water was metered, the metering apparatus was rinsed with 10 g of demineralized water and the reaction mixture was then stirred for a further hour for postpolymerization at 50° C. A milky white dispersion having a viscosity of 1600 mPa·s was obtained. A 0.5% strength aqueous solution of this dispersion had a viscosity of 29 000 mPa·s at pH 7.

### Example 9

In a glass reactor which was equipped with an anchor stirrer and an apparatus for working under nitrogen, 359 g of demineralized water, 87.5 g of a block copolymer of ethylene oxide (EO) and propylene oxide (PO) having an EO content of 20% and a molar mass of 1750 g/mol of the polypropylene glycol block, 87.5 g of a copolymer of 20.3 parts of propylene oxide and 14.2 parts of ethylene oxide and 250 g of a 10% strength aqueous solution of a copolymer of 80 mol % of methacrylic acid and 20 mol % of the sodium salt of acrylamidomethylpropanesulfonic acid were initially taken while passing through nitrogen and stirring continuously at a speed of 200 rpm.

Thereafter, while stirring (200 rpm), a mixture of 174 g of acrylic acid and 1.75 g of pentaerythrityl triallyl ether (70% strength) was added dropwise in the course of 5 minutes and the resulting emulsion was heated to 35° C. After addition of a solution of 0.2 g of azo initiator V-70 in 10 g of water and rinsing of the metering apparatus with 10 g of water, the reaction mixture was heated to a temperature of 50° C. and polymerized at this temperature for 4 hours. Thereafter, a solution of 0.3 g of azo initiator V-70 in 10 g of demineralized water was metered, the metering apparatus was rinsed with 10 g of demineralized water and the reaction mixture was then stirred for a further hour for postpolymerization at 35° C. A milky white dispersion having a viscosity of 1400 mPa·s was obtained. A 0.5% strength aqueous solution of this dispersion had a viscosity of 32 000 mPa·s at pH 7.

### Example 10

Example 1 was repeated with the exceptions that a solution of 87.5 g of a block copolymer of ethylene oxide (EO) and propylene oxide (PO) having an EO content of 20% and a molar mass of 1750 g/mol of the polypropylene glycol block, 87.5 g of a copolymer of 20.3 parts of propylene oxide and 14.2 parts of ethylene oxide, 53.4 g of a 45% strength aqueous polyacrylic acid having a molar mass M_{w} of 50 000 and 555.7 g of demineralized water was initially taken. An aqueous dispersion having a viscosity of 2000 mPa·s was obtained. A 0.5% strength aqueous solution of this dispersion had a viscosity 26 000 mPa·s at pH 7.

### Example 11

Example 1 was repeated with the exceptions that a solution of 87.5 g of a block copolymer of ethylene oxide (EO) and propylene oxide (PO) having an EO content of 20% and a molar mass of 1750 g/mol of the polypropylene glycol block, 87.5 g of a copolymer of 20.3 parts of propylene oxide and 14.2 parts of ethylene oxide, 120 g of a 20% strength aqueous solution of polyacrylamidomethylpropanesulfonic acid and 555.7 g of demineralized water was initially taken. An aqueous dispersion having a viscosity of 1900 mPa·s was obtained. A 0.5% strength aqueous solution of this dispersion had a viscosity of 28 000 mPa·s at pH 7.

### Example 12

Example 11 was repeated with the only exception that, in the initially taken mixture, the polyacrylamidomethylpropanesulfonic acid was replaced by the same amount of 20% strength aqueous polymethacrylic acid having a molar mass M_{w} of 40 000. An aqueous dispersion having a viscosity of 1900 mPa·s was obtained. A 0.5% strength aqueous solution of this dispersion had a viscosity of 36 000 mPa·s at pH 7.

### Example 13

Example 6 was repeated with the only exception that, instead of pentaerythrityl triallyl ether, 1.75 g of a 10% strength aqueous solution of an ethoxylated trimethylolpropane triacrylate were now used as the crosslinking agent. An aqueous dispersion having a viscosity of 900 mPa·s was obtained. A 0.5% strength aqueous solution of this dispersion had a viscosity of 34 000 mPa·s at pH 7.

### Example 14

Example 6 was repeated with the only exception that, instead of pentaerythrityl triallyl ether, 4.35 g of a 10% strength aqueous solution of triallylamine were now used as the crosslinking agent. An aqueous dispersion having a viscosity of 1000 mPa·s was obtained. A 0.5% strength aqueous solution of this dispersion had a viscosity of 38 000 mPa·s at pH 7.

### Example 15

Example 1 was repeated with the exceptions that a solution of 87.5 g of a block copolymer of ethylene oxide (EO) and propylene oxide (PO) having an EO content of 20% and a molar mass of 1750 g/mol of the polypropylene glycol block, 87.5 g of a copolymer of 20.3 parts of propylene oxide and 14.2 parts of ethylene oxide, 250 g of a 10% strength aqueous solution of a copolymer of 60 mol % of methacrylic acid, 20 mol % of the sodium salt of acrylamidomethylpropanesulfonic acid and 20 mol % of a vinylimidazole quaternized with methyl chloride and 359 g of demineralized water were used as the initially taken mixture. A dispersion having a viscosity of 2000 mPa·s was obtained. A 0.5% strength aqueous solution of this dispersion had a viscosity of 20 000 mPa·s at pH 7.

### Example 16

Example 1 was repeated with the exceptions that a solution of 87.5 g of a block copolymer of ethylene oxide (EO) and propylene oxide (PO) having an EO content of 20% and a molar mass of 1750 g/mol of the polypropylene glycol block, 87.5 g of a copolymer of 20.3 parts of propylene oxide and 14.2 parts of ethylene oxide, 250 g of a 10% strength aqueous solution of a copolymer of 20 mol % of methacrylic acid, 69 mol % of the sodium salt of acrylamidomethylpropanesulfonic acid, 10 mol % of a vinylimidazole quaternized with methyl chloride and 1 mol % of styrene and 359 g of demineralized water were used as the initially taken mixture. A dispersion having a viscosity of 900 mPa·s was obtained. A 0.5% strength aqueous solution of this dispersion had a viscosity of 22 000 mPa·s at pH 7.

### Example 17

Example 1 was repeated, with the exceptions that a solution of 175 g of polyethylene glycol having a molar mass M_{w} of 1500, 250 g of a 10% strength aqueous solution of a copolymer of 80 mol % of methacrylic acid and 20 mol % of the sodium salt of acrylamidomethylpropanesulfonic acid and 359 g of demineralized water were used as the initially taken mixture. A dispersion having a viscosity of 2500 mPa·s was obtained. A 0.5% strength aqueous solution of this dispersion had a viscosity of 34 000 mPa·s at pH 7.

### Example 18

In a glass reactor which was equipped with an anchor stirrer and an apparatus for working under nitrogen, 479.8 g of demineralized water, 106.7 g of a block copolymer of ethylene oxide (EO) and propylene oxide (PO) having an EO content of 20% and a molar mass of 1750 g/mol of the polypropylene glycol block, 53.3 g of a copolymer of 20.3 parts of propylene oxide and 14.2 parts of ethylene oxide and 110 g of a 20% strength aqueous solution of a copolymer of 59 parts of acrylamidomethylpropanesulfonic acid, 20 parts of methyl acrylate, 20 parts of acrylic acid and 1 part of styrene were initially taken while passing through nitrogen and stirring continuously at a speed of 200 rpm.

Thereafter, while stirring (200 rpm), a mixture of 139.2 g of acrylic acid and 69.55 g of a 50% strength aqueous solution of a dimethylaminoethyl methacrylate quaternized with diethyl sulfate and 1.5 g of pentaerythrityl triallyl ether (70% strength) was added dropwise in the course of 5 minutes and the resulting emulsion was heated to 40° C. After addition of a solution of 0.2 g of azo initiator VA-044 in 10 g of water and rinsing of the metering apparatus with 10 g of water, the reaction mixture was heated to a temperature of 40° C. and kept at this temperature for 4 hours. Thereafter, a solution of 0.3 g of azo initiator VA-044 in 10 g of demineralized water was metered, the metering apparatus was rinsed with 10 g of demineralized water and the reaction mixture was then stirred for a further hour for postpolymerization at 40° C. A milky white dispersion having a viscosity of 1850 mPa·s was obtained. A 0.5% strength aqueous solution of this dispersion had a viscosity of 12 150 mPa·s at pH 7.

1. An aqueous dispersion of water-soluble and/or water-swellable anionic polymers which are obtainable by free radical polymerization of ethylenically unsaturated, anionic monomers in an aqueous medium in the presence of at least one stabilizer, if the polymerization is carried out in the presence of at least one water-soluble polymer selected from the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, polyalkylene glycols endcapped at one or both ends with alkyl, carboxyl or amino groups
and
(b) water-soluble copolymers selected from the group consisting of
homo- and copolymers of anionic monomers,
copolymers of anionic and cationic and, if appropriate, neutral monomers, the proportion of the anionic monomers incorporated in the form of polymerized units being greater than that of cationic monomers and
copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate
as a stabilizer.

2. The aqueous dispersion according to claim 1, wherein the polyalkylene glycols having molar masses M_{N} of from 100 to 100 000 and/or polyalkylene glycols endcapped at one or both ends with alkyl, carboxyl or amino groups and having molar masses M_{N} of from 100 to 100 000 are used as water-soluble polymers of group (a).

3. The aqueous dispersion according to claim 1, wherein the block copolymers of ethylene oxide and propylene oxide having a molar mass M_{N} of from 500 to 20 000 g/mol and a content of ethylene oxide units of from 10 to 80 mol % are used as water-soluble polymers of group (a).

4. The aqueous dispersion according to claim 1, wherein at least one homopolymer of an ethylenically unsaturated C₃- to C₅-carboxylic acid, vinylsulfonic acid, styrenesulfonic acid, acrylamidomethylpropanesulfonic acid, vinylphosphonic acid or of the salts thereof partly or completely neutralized with alkali metal and/or ammonium bases and/or at least one copolymer of these monomers are used as water-soluble polymers of group (b).

5. The aqueous dispersion according to claim 1, wherein copolymers of
(i) at least one ethylenically unsaturated C₃- to C₅-carboxylic acid, vinylsulfonic acid, styrenesulfonic acid, acrylamidomethylpropanesulfonic acid, vinylphosphonic acid and/or the alkali metal and/or ammonium salts thereof,
(ii) at least one cationic monomer from the group consisting of partly or completely neutralized dialkylaminoalkyl (meth)acrylates, partly or completely quaternized dialkylaminoalkyl (meth)acrylates, dialkylaminoalkyl(meth)acrylamides in quaternized or neutralized form, dialkyldiallylammonium halides and quaternized N-vinylimidazole and, if appropriate, and
(iii) at least one neutral monomer
are used as water-soluble polymers of group (b), the proportion of the anionic monomers incorporated in the form of polymerized units being greater than that of the cationic monomers.

6. The aqueous dispersion according to claim 1, wherein copolymers of
(i) at least one anionic monomer and
(ii) at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate
are used as water-soluble polymers of group (b).

7. The aqueous dispersion according to claim 1, wherein at least one monoethylenically unsaturated C₃- to C₅-carboxylic acid, vinylsulfonic acid, styrenesulfonic acid, acrylamidomethylpropanesulfonic acid, vinylphosphonic acid and/or the alkali metal or ammonium salts of these acids are used as anionic monomers.

8. The aqueous dispersion according to claim 1, wherein the polymerization of the anionic monomers is additionally carried out in the presence of at least one other monomer from the group consisting of acrylamide, methacrylamide, acrylates of monohydric alcohols having 1 to 20 carbon atoms, methacrylates of monohydric alcohols having 1 to 20 carbon atoms, vinyl acetate, vinyl propionate, dialkylaminoethyl (meth)acrylates, dialkylaminopropyl (meth)acrylates, diallyldimethylammonium chloride, N-vinylformamide, vinylimidazole, quaternized vinylimidazole, partly or completely neutralized or quaternized dimethylaminoalkyl (meth)acrylates and partly or completely neutralized or quaternized dialkylaminoalkyl(meth)acrylamides.

9. The aqueous dispersion according to claim 1, wherein the polymerization of the anionic monomers is additionally carried out in the presence of at least one crosslinking agent.

10. The aqueous dispersion according to claim 1, wherein pentaerythrityl triallyl ether, N,N′-divinylethyleneurea, methylenebisacrylamide, esters of dihydric alcohols having 2 to 8 carbon atoms and C₃- to C₅-carboxylic acids, ethoxylated trimethylolpropane triacrylate, ethoxylated trimethylolpropane trimethacrylate, pentaerythrityl triacrylate, pentaerythrityl tetraacrylate, triallylmethylammonium chloride, allyl ethers of sugars, which allyl ethers comprise at least two allyl groups, vinyl ethers having at least two vinyl groups or triallylamine and mixtures of these compounds are used as crosslinking agents.

11. The aqueous dispersion according to claim 1, which is obtainable by polymerization of acrylic acid in the absence of other monomers.

12. The aqueous dispersion according to claim 1, which is obtainable by polymerization of acrylic acid and/or methacrylic acid in the presence of pentaerythrityl triallyl ether, N,N′-divinylethyleneurea, triallylamine, methylenebisacrylamide, esters of dihydric alcohols having 2 to 8 carbon atoms and ethylenically unsaturated C₃- to C₅-carboxylic acids, ethoxylated trimethylolpropane triacrylate, ethoxylated trimethylolpropane trimethacrylate, pentaerythrityl triacrylate, pentaerythrityl tetraacrylate and/or triallylmethylammonium chloride.

13. A process for the preparation of aqueous dispersions of water-soluble and/or water-swellable anionic polymers by free radical polymerization of ethylenically unsaturated, anionic monomers in an aqueous medium in the presence of at least one stabilizer, the polymerization being carried out in the presence of at least one water-soluble polymer of the groups consisting of
(a) graft polymers of vinyl acetate and/or vinyl propionate on (i) polyethylene glycols or (ii) polyethylene glycols or polypropylene glycols endcapped at one or both ends with alkyl, carboxyl or amino groups, polyalkylene glycols, polyalkylene glycols endcapped at one or both ends with alkyl, carboxyl or amino groups
and
(b) water-soluble copolymers from the group consisting of
homo- and copolymers of anionic monomers,
copolymers of anionic and cationic and, if appropriate, neutral monomers, the proportion of the anionic monomers incorporated in the form of polymerized units being greater than that of cationic monomers and
copolymers of at least one anionic monomer and at least one monomer from the group consisting of the esters of anionic monomers with monohydric alcohols, styrene, N-vinylpyrrolidone, N-vinylcaprolactam, N-vinylimidazole, N-vinylformamide, acrylamide, methacrylamide, vinyl acetate and vinyl propionate
as a stabilizer.

14-15. (canceled)

16. A method for preparing thickeners for aqueous systems comprising admixing the aqueous dispersion of claim 1 to other components of the system.

17. The method of claim 16, wherein the aqueous dispersions are used as thickeners for paper coating slips, pigment print pastes, print pastes for transfer printing, dispersion printing, printing with acid or metal complex dyes, reactive printing or vat printing, for tertiary mineral oil production, for consolidating nonwovens, for water-based paints, for dental compounds, for pharmaceutical products, agrochemicals and extinguishing agents and as coating material and as an additive in detergents and cleaning agents.
